(19) United States
(12) Patent Application Publication
(10) Pub. No.: US 2026/0358758 A1
(43) Pub. Date: Nov. 12, 2026

(54) Illumination System for Forming a Light Pattern

(71) Applicant: Envisics Ltd, Milton Keynes (GB)

(72) Inventor: Alexander Cole, Milton Keynes (GB)

(21) Appl. No.: 19/490,784

(22) PCT Filed: Jun. 24, 2024
(86) PCT No.: PCT/EP2024/067629

§ 371 Date: Dec. 5, 2025

(30) Foreign Application Priority Data
Jun. 26, 2023 (GB) 2309578.9

(51) Int. Cl. G03H 1/22

(52) U.S. Cl. CPC G03H 1/2294; G03H 1/2202

(57) ABSTRACT

An illumination system for forming a light pattern comprises a first telescope and a second telescope. Each of the first and second telescopes comprises a respective first array of micro-lenses arranged to receive light from a light source. Each of the first and second telescopes comprises a respective second array of micro-lenses. Each micro-lens of the respective first array is optically coupled to a respective micro-lens of the second array to form an array of micro-lens pairs. Each micro-lens pair is arranged to concentrate a portion of the received light into a local beam having reduced diameter relative to the received light, such that each of the first and second telescopes forms a respective light pattern comprising an array of discrete light regions. The illumination system comprises an optical component arranged to spatially interlace the respective light patterns to produce a spatially interlaced light pattern.

### FIELD

The present disclosure relates to an illumination system and a method for forming a light pattern by an illumination system. More specifically, the present disclosure relates to a an illumination system for forming a light pattern which provides striped or chequered liquid crystal on silicon illumination. Some embodiments relate to a holographic projector, picture generating unit or head-up display.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator (SLM) arranged to modulate the amplitude and/or phase of incident light. Light modulation may be achieved using electrically-addressable liquid crystals, optically-addressable liquid crystals or micro-mirrors, for example.

A SLM typically comprises a plurality of individually-addressable pixels which may also be referred to as cells or elements. The light modulation scheme may be binary, multilevel or continuous. Alternatively, the device may be continuous (i.e. not comprised of pixels) and light modulation may therefore be continuous across the device. The SLM may be reflective, meaning that modulated light is output in reflection. The SLM may equally be transmissive, meaning that modulated light is output in transmission.

A holographic projector may be provided using embodiments described herein. Such projectors have found application in head-up displays, “HUDs”.

### SUMMARY

Aspects of the present disclosure are defined in the appended independent claims.

In general terms, there is provided an illumination system for illuminating a display device such as a spatial light modulator. In particular, the display device may be for displaying holograms, for example a plurality of hologram each hologram being of a different picture, simultaneously. The illumination system is arranged to form an illumination pattern. The illumination pattern may be suitable for illuminating the display device. In particular, the illumination pattern may be suitable for multi-channel illumination of the display device. As used herein, a channel may refer to light of a particular (e.g. single) wavelength. Multi-channel illumination of the display device may mean that the display device is illuminated with light of a plurality of wavelengths/wavelengths. The illumination system may be arranged to form a light pattern for illuminating the display device with the light of a plurality wavelengths/channels simultaneously. The illumination system may be arranged to form a light pattern for illuminating discrete portions of the display device with the light of different wavelengths/channels (simultaneously). For example, the illumination pattern may be arranged to illuminate a sub-set of first discrete areas of the display device with light of a first wavelength/channel and a sub-set of second discrete areas with light of a second wavelength/channel. In some examples, the display device may be arranged to display a first hologram in the sub-set of first discrete areas and a second hologram in the second sub-set of second discrete areas. In this way, the first hologram may be illuminated with light of the first wavelength/channel and the second hologram may be illuminated with light of the second wavelength/channel. Thus, light of the first wavelength/channel may be spatially modulated in accordance with the first hologram and light of the second wavelength /channel may be spatially modulated in accordance with the second hologram. The first hologram may be a hologram of a first picture (intended to be illuminated by a first wavelength of light). The second hologram may be a hologram of a second picture (intended to be illuminated by a second wavelength of light). When the first and second pictures are holographically reconstructed and the reconstructions are combined, a multi-wavelength/ multi-colour reconstruction may be formed. The skilled reader will appreciate that the concept of the illumination system according to the present disclosure can be extended to a three-channel system in which red, green and blue light is used to illuminate first, second and third holograms respectively (of first, second and third pictures). The skilled reader will appreciate that such an illumination system may be suitable for forming full-colour holographic reconstructions by combining red, green and blue holographic reconstructions of appropriately selected first, second and third pictures, respectively.

In more detail, the inventors have recognised that, for each channel, the illumination system may comprise a telescope comprising respective first and second arrays of micro-lenses, wherein pairs of micro-lenses are formed, each pair comprising a respective micro-lens from the first and second arrays. Each pair is arranged to receive and concentrate (e.g. focus) a portion of the light received by the telescope to form a light pattern comprising an array of discrete light regions. Each of the discrete light regions within a channel may be spatially separated. Specifically, the discrete light regions of each channel may be arranged such that the light pattern of channels can be spatially interlaced with each other. The inventors have recognised that said telescope (for each channel) advantageously forms spatially separated discrete light regions (such that channels can be spatially interlaced) without wasting light/without substantial loss of light. In particular, by concentrating the portions of light, the pairs of micro-lenses output relatively smaller discrete portions of light each portion having increased light density (relative to an input light beam). Thus, a light density of a particular channel illuminating the display device averaged over the full area of the device may be substantially the same as in the absence of the telescope. This would not be the case, for example, if a mask were used to block portions of light of the/each channel to form the discrete light regions. In such cases, the intensity of light of a particular channel illuminating the display device averaged over the full area of the display device would be reduced (for example, substantially halved in a two-channel system or substantially thirded in a three-channel system). The inventors have recognised that such a masking arrangement would be prohibitively optically inefficient. The inventors have recognised that the proposed illumination system efficiently illuminates a display device with a plurality of channels of light.

Conventionally, a system achieves a multi-channel arrangement either: using a separate display device for each channel; or, if a single display device is desired, sequentially illuminating that (single) display device with different light channels (while displaying respective content for that channel), i.e. by time interlacing. The inventors have recognised that the described light pattern (comprising discrete light regions) advantageously enables a single display device to be illuminated with a plurality of light channels simultaneously (i.e. using spatial interlacing rather than time interlacing). This advantageously reduces the complexity of the system without the added complexities of time interlacing. The inventors have further recognised that the proposed multi-channel illumination system is particularly suitable for use with a display device arranged to display a plurality of holograms (simultaneously), rather than a conventional display device arranged to display a plurality of images. The inventors have recognised that, in conventional display, it is not practical to display a plurality of (different) images simultaneously in different (discrete) sub-regions of the display device. For example, it is not practical to spatially interlace a first image and a second image on the display device (in the conventional image domain). However, the inventors have recognised that, in the hologram domain, a single hologram may be distributed over a plurality of spatially separated discrete regions or portions of a display device without adversely affecting the viewing experience. For example, a holographic reconstruction of the picture of a hologram may still be formed despite gaps or holes being present in the hologram. Thus, the inventors have recognised that a plurality of holograms can be spatially interlaced (simultaneously) on a display device without adversely affecting the holographic reconstruction formed by each respective hologram.

In an aspect, there is provided an illumination system for forming a light pattern, wherein the illumination system comprises a telescope. The telescope comprises a first array of micro-lenses arranged to receive light, which may be collimated light, from a light source. The telescope further comprises a second array of micro-lenses. Each micro-lens of the first array is optically coupled to a respective micro-lens of the second array thereby to form an array of micro-lens pairs. Each micro-lens pair of the array of micro-lens pairs is arranged to concentrate (e.g. focus) a portion of the received light into a local beam having a reduced diameter relative to the received light. Said received light refers to the received that is received by the respective micro-lens pair (e.g. by a respective lens of the first array of micro-lenses). Thus, the diameter of the local beam is reduced compared to the light that is received by the respective micro-lens pair (rather than the full diameter of input beam to the first array). A “local beam” may refer to the beam formed by each respective micro-lens pair. There may be a local beam formed by each micro-lens pair. The telescope may be arranged such that a light pattern is formed, which may be collimated. The light pattern comprises an array of discrete light regions. Adjacent discrete light regions of the array may be spatially separated from one another.

In a further aspect, there is provided an illumination system for forming a light pattern. The illumination system comprises a first telescope and a second telescope. Each of the first telescope and the second telescope comprises a respective first array of micro-lenses arranged to receive light, which may be collimated, from a light source. Each of the first telescope and the second telescope further comprises a respective second array of micro-lenses. Each micro-lens of the respective first array is optically coupled to a respective micro-lens of the second array thereby to form an array of micro-lens pairs. Each micro-lens pair of the array of micro-lens pairs is arranged to concentrate a portion of the received light into a local beam having a reduced diameter relative to the received light, such that each of the first telescope and the second telescope forms a respective light pattern, which may be collimated. Each respective light pattern comprises a respective array of discrete light regions. Adjacent discrete light regions of each array may be spatially separated from one another. The illumination system further comprises an optical component, which may be a beam splitter or multiplexing (shorthand, “muxing”) cube, arranged to spatially interlace the respective light patterns of the first telescope and the second telescope, thereby to produce a spatially interlaced light pattern. For example, the optical component may be arranged such that the (spatially separated) discrete light portions of the light pattern of the second telescope are positioned in spaces or gaps between the (spatially separated) discrete light portions of the light pattern of the first telescope. The discrete light portions of the light pattern of the first telescope may not overlap with the discrete light portions of the light pattern of the second telescope.

Advantageously, spatially interlacing the respective light patterns in this way tends to allow for illumination of a (pixellated) display device such as a spatial light modulator (e.g.

liquid crystal on silicon SLM) in a striped or chequered pattern, thereby to broadly cover a footprint of the active area of the LCOS without undesirable loss of illumination intensity.

Such a system tends to enable use of single LCOS device without the time-sequential challenges associated with conventional systems having a plurality, e.g. three or more, LCOS devices.

The spatially interlaced light pattern may form a striped or chequerboard pattern.

The illumination system may further comprise a display device for displaying holograms, which display device may be a spatial light modulator. Each of the first telescope and the second telescope is arranged to relay light to the display device such that the display device is illuminated by the spatially interlaced light pattern.

The illumination system may further comprise a driver arranged to drive the display device to display thereon a first hologram of a first picture.

The driver may be arranged to drive the display device to display the first hologram on a plurality of spatially separated first sub-areas of the display device. The spatially separated first sub-areas of the display device may form a pattern that corresponds to the light pattern of the first telescope.

The illumination system may be arranged such that the light pattern of the first telescope illuminates each sub-area of the plurality of spatially separated first sub-areas of the display device. Light of the first light pattern may thus be spatially modulated in accordance with the first hologram.

The driver may be arranged to drive the display device to display thereon a second hologram of a second picture simultaneously to displaying the first hologram of the first picture.

The driver may be arranged to drive the display device to display the second hologram on a plurality of spatially separated second sub-areas of the display device. The respective pluralities of spatially separated first and second sub-areas of the display device may thus be spatially interlaced. Each first sub-area of the display device may, optionally, not overlap a second sub-area of the display device.

The illumination system may be arranged such that the second light pattern of the second telescope illuminates each of the sub-area of the plurality of spatially separated second sub-areas of the display device. Thus light of the second light pattern may be spatially modulated in accordance with the second hologram.

The illumination system may comprise a light source, which may be a coherent light source, arranged to emit light. The first telescope may be arranged to receive the light emitted from the first light source.

The illumination system may further comprise a further light source, which may be a coherent light source, arranged to emit light which may have a wavelength different to that of the light emitted by the light source. The second telescope may be arranged to receive the light emitted from the second light source.

A dimension, which may be an area or a width, of one or more micro-lenses of the first array of micro-lenses may be larger than a corresponding dimension of one or more micro-lenses of the second array of micro-lenses.

A dimension of each of the micro-lenses of the first array of micro-lenses may be larger than a corresponding dimension of each of the micro-lenses of the second array of micro-lenses.

The respective light patterns of the first and second telescopes may each comprise a respective array of spatially separated light regions.

For each array of discrete light regions, a spatial separation between at least one pair of neighboring discrete light regions may be greater than or substantially equal to a width, which may be a maximum width, of at least one of the discrete light regions of the array of discrete light regions.

The separation between the at least one pair of neighboring light regions may be greater than or substantially equal to double the width of the at least one of the discrete light regions of the array of discrete light regions.

Each of the discrete light regions of the array of discrete light regions may have substantially the same width.

Each of the first telescope and the second telescope may be arranged such that an intensity of the light received at the first array of micro-lenses is less than an intensity of light output by the second array of micro-lenses. Each of the first telescope and the second telescope may be arranged such that an intensity of the light received at the first array of micro-lenses may be half or less than half, or a third or less than a third, of the intensity of light output by the second array of micro-lenses.

A focal point of each of the first array of micro-lenses may lie on a common focal plane. An optical power/focal length of each micro-lens of the first array of micro-lenses may be the same.

A focal point of each of the second array of micro-lenses may lie on a further common focal plane. An optical power of each micro-lens of the second array of micro-lenses may be the same.

The first array of micro-lenses may comprise a one-dimensional array of micro-lenses and/or a two-dimensional array of micro-lenses.

The first array of micro-lenses and/or the second array of micro-lenses may comprise an array of cylindrical micro-lenses.

Each of the first telescope and the second telescope may further comprise a collimation lens upstream of the first array of micro-lenses. The respective collimation lenses may be positioned between the light source and the first array of the respective telescope.

In a further aspect, there is provided a method for forming a light pattern by an illumination system. The method comprises receiving, by a first array of micro-lenses of a first telescope light, which may be collimated. Each micro-lens of the first array of micro-lenses is optically coupled to a respective micro-lens of a second array of micro-lenses of the first telescope, thereby to form an array of micro-lens pairs. The method further comprises receiving, by a further first array of micro-lenses of a second telescope light, which may be collimated. Each micro-lens of the further first array of micro-lenses is optically coupled to a respective micro-lens of a further second array of micro-lenses of the second telescope, thereby to form a further array of micro-lens pairs. The method further comprises concentrating, by each micro-lens pair of the array of micro-lens pairs and the further array of micro-lens pairs, a respective portion of the received light into a respective local beam. Each respective local beam has a reduced diameter relative to the respective portion of the received light, such that each of the first telescope and the second telescope forms a respective light pattern, which may be collimated. Each respective light pattern comprises a respective array of discrete light regions. The method further comprises spatially interlacing, by an optical component of the illumination system, which may be a beam splitter or muxing cube, the respective light patterns of the first telescope and the second telescope, thereby to produce a spatially interlaced light pattern.

Advantageously, spatially interlacing the respective light patterns in this way tends to allow for illumination of a (pixellated) display device such as a spatial light modulator (e.g. liquid crystal on silicon SLM) in a striped or chequered pattern, thereby to broadly cover a footprint of the active area of the LCOS without undesirable loss of illumination intensity.

Such a system tends to enable use of single LCOS device without the time-sequential challenges associated with conventional systems having multiple, e.g. three or more, LCOS devices.

The spatially interlaced light pattern may form a striped or chequerboard pattern.

The method may further comprise relaying, by the first telescope and the second telescope, light to a display device such that the display device is illuminated by the spatially interlaced light pattern.

The method may further comprise driving, by a driver, the display device to display thereon a first hologram of a first picture.

The method may further comprise driving, by the driver, the display device to display the first hologram on a plurality of spatially separated first sub-areas of the display device.

The spatially separated first sub-areas of the display device may form a pattern that corresponds to the light pattern of the first telescope.

The method may further comprise illuminating, by the light pattern of the first telescope, each sub-area of the plurality of spatially separated first sub-areas of the display device. Thus, light of the first light pattern may be spatially modulated in accordance with the first hologram.

The method may further comprise driving, by the driver, the display device to display thereon a second hologram of a second picture simultaneously to displaying the first hologram of the first picture.

The method further comprises driving, by the driver, the display device to display the second hologram on a plurality of spatially separated second sub-areas of the display device. The respective pluralities of spatially separated first and second sub-areas of the display device are spatially interlaced. Each first sub-area of the display device may thus, optionally, not overlap a second sub-area of the display device.

The method may further comprise illuminating, by the second light pattern of the second telescope, each of the sub-areas of the plurality of spatially separated second sub-areas of the display device such that light of the second light pattern is spatially modulated in accordance with the second hologram. Light of the second light pattern may thus be spatially modulated in accordance with the second hologram.

The method may further comprise receiving, by the first telescope, light, which may be coherent, emitted from a first light source.

The method may further comprise receiving, by the second telescope, light, which may be coherent, emitted from a second light source.

A dimension, which may be an area or a width, of one or more micro-lenses of the first array of micro-lenses may be larger than a corresponding dimension of one or more micro-lenses of the second array of micro-lenses.

A dimension of each of the micro-lenses of the first array of micro-lenses may be larger than a corresponding dimension of each of the micro-lenses of the second array of micro-lenses.

The respective light patterns of the first and second telescopes may each comprise a respective array of spatially separated light regions.

For each array of discrete light regions, a spatial separation between at least one pair of neighboring discrete light regions may be greater than or substantially equal to a width, which may be a maximum width, of at least one of the discrete light regions of the array of discrete light regions.

The separation between the at least one pair of neighboring light regions may be greater than or substantially equal to double the width of the at least one of the discrete light regions of the array of discrete light regions.

Each of the discrete light regions of the array of discrete light regions may have substantially the same width.

Each of the first telescope and the second telescope may be arranged such that an intensity of the light received at the first array of micro-lenses may be less than an intensity of light output by the second array of micro-lenses. Each of the first telescope and the second telescope may be arranged such that an intensity of the light received at the first array of micro-lenses may be half or less than half, or a third or less than a third, of the intensity of light output by the second array of micro-lenses.

A focal point of each of the first array of micro-lenses may lie on a common focal plane. An optical power of each micro-lens of the first array of micro-lenses may be the same.

A focal point of each of the second array of micro-lenses may lie on a further common focal plane. An optical power of each micro-lens of the second array of micro-lenses may be the same.

The first array of micro-lenses may comprise a one-dimensional array of micro-lenses and/or a two-dimensional array of micro-lenses.

The second array of micro-lenses may comprise a further one-dimensional array of micro-lenses and/or a further two-dimensional array of micro-lenses.

The first array of micro-lenses and/or the second array of micro-lenses may comprise an array of cylindrical micro-lenses.

Each of the first telescope and the second telescope may further comprise a collimation lens upstream of the first array of micro-lenses. The collimation lens may be positioned between the light source and the first array of the respective telescope.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the SLM described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a SLM and illuminated with light having a wavelength comparable to, and generally less than, the pixel pitch of the spatial light modulator.

Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described hereinafter, by way of example only, with reference to the accompanying figures in which:

FIG. 1 is a schematic illustration depicting a reflective spatial light modulator producing a holographic reconstruction on a screen;

FIG. 2 is a schematic illustration depicting an image for projection comprising eight image areas/components and cross-sections of corresponding hologram channels;

FIG. 3 is a schematic illustration depicting a hologram displayed on an LCOS that directs light into a plurality of discrete areas;

FIG. 4 is a schematic illustration depicting a system including a display device which displays a hologram calculated as outlined in the descriptions of FIGS. 2 and 3;

FIG. 5A is a perspective view depicting an exemplary two-dimensional pupil expander comprising two replicators, each of which comprises a pair of stacked surfaces;

FIG. 5B is a perspective view depicting an exemplary two-dimensional pupil expander comprising two replicators, each in the form of a solid waveguide;

FIG. 6A is a schematic illustration depicting an illumination system comprising a collimation lens and two sequential arrays of micro-lenses which together form a set of respective micro-lens pairs;

FIG. 6B is a schematic illustration depicting a striped arrangement of micro-lenses in an array and a chequered arrangement of micro-lenses in an array;

FIG. 7A is a schematic illustration depicting a further illumination system having a two-channel arrangement in which two sets of micro-lens pairs are formed;

FIG. 7B is a schematic illustration depicting a striped pattern formed on a display device; and

FIG. 7C is a schematic illustration depicting a chequerboard pattern formed on a display device.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship-for example, when the temporal order of events is described as “after”, “subsequent”, “next”, “before” or suchlike-the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

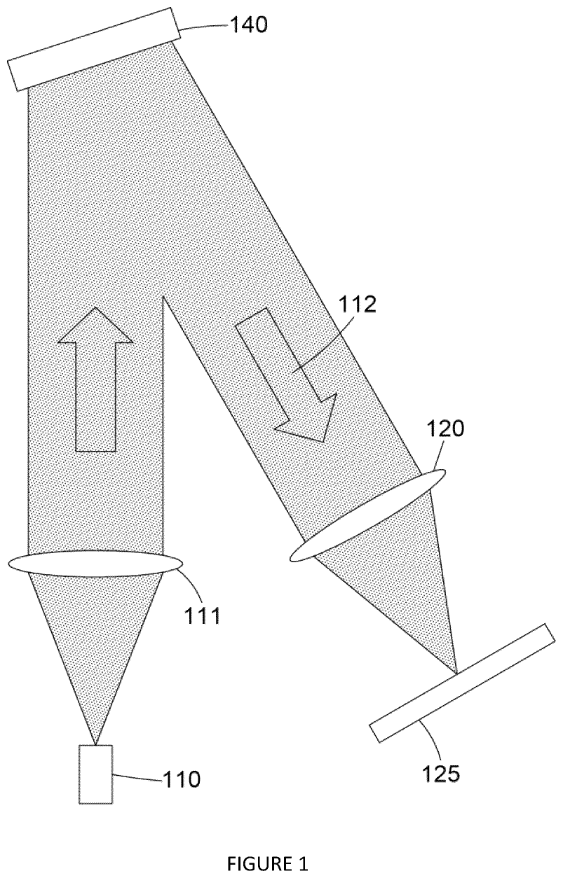

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform. In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms.

Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator.

The region of the extended modulator is also an aperture in accordance with this disclosure. In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

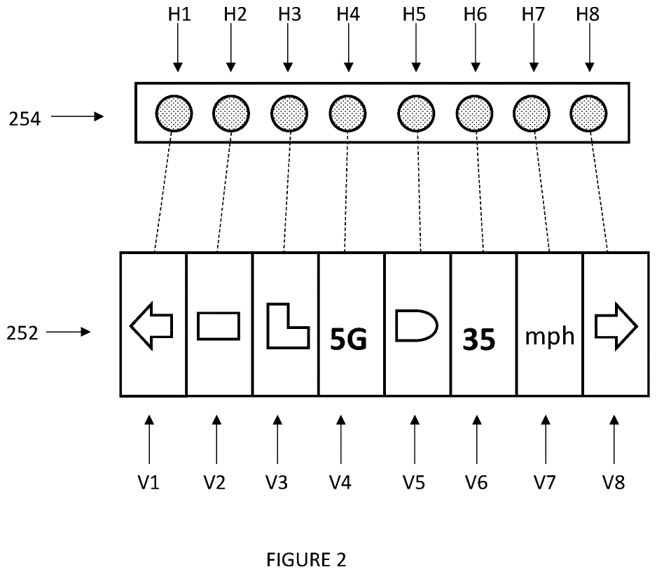

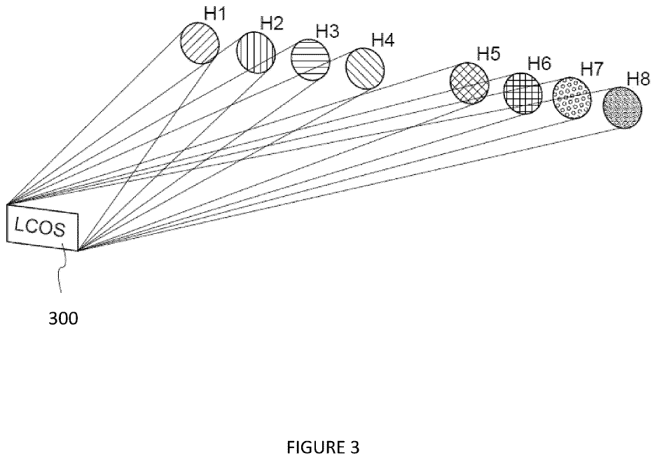

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252 e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

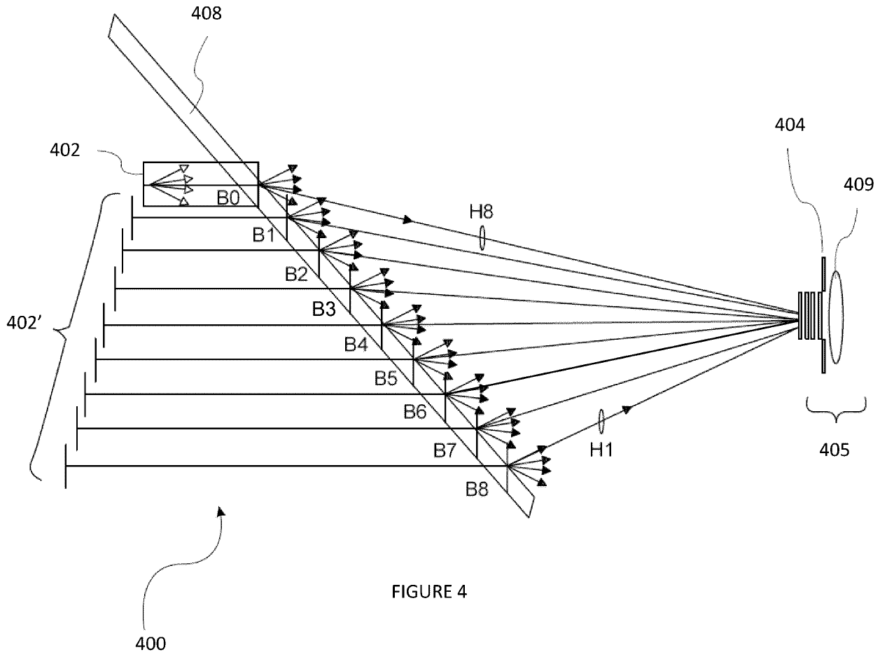

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

The waveguide 408 forms a plurality of replicas of the hologram, at the respective bounce points B1-B8 along its length, corresponding to the direction of pupil expansion. As shown in FIG. 4, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

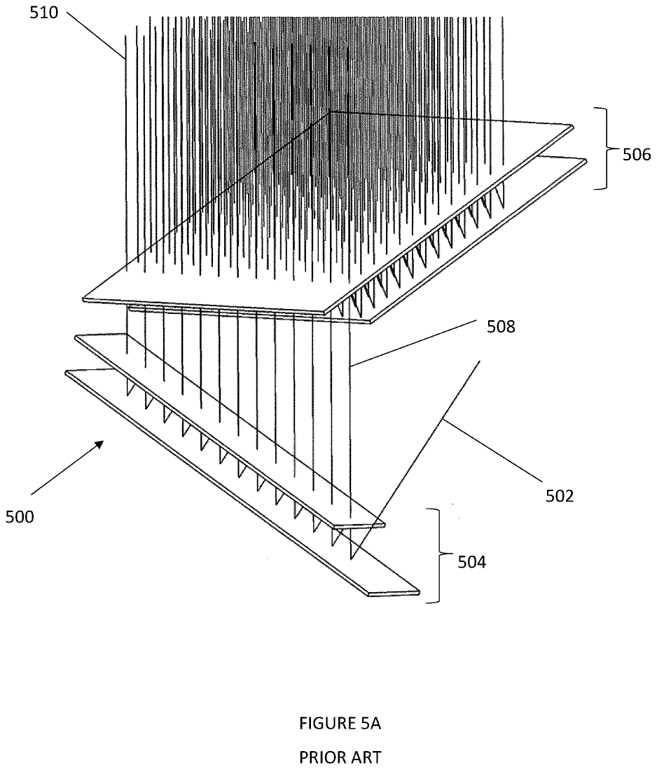

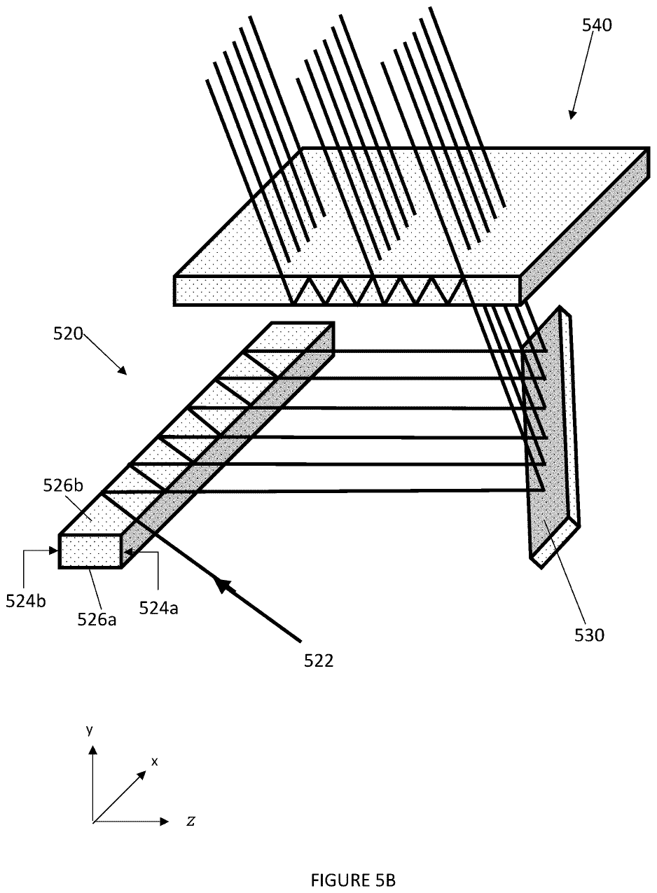

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light-comprising a one-dimensional array of replicas extending in the first dimension-from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device-such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM-determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

### Patterned Illumination of SLM

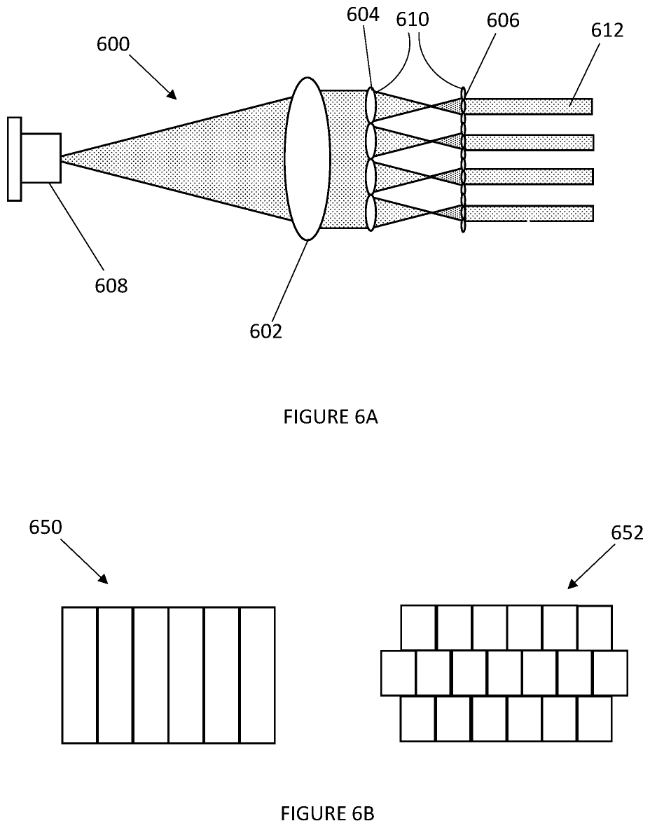

FIG. 6A depicts an illumination system 600 comprising a collimation lens 602, a first array of micro-lenses 604, and a second array of micro-lenses 606. The illumination system 600 of this embodiment also comprises a light source 608, although in some embodiments the light source 608 may be external to the illumination system 600.

Together, the first array of micro-lenses 604 and the second array of micro-lenses 606 may be considered to form a set of respective micro-lens pairs 610, in which set of respective micro-lens pairs 610 each micro-lens pair comprises a micro-lens of the first array of micro-lenses 604 and a micro-lens of the second array of micro-lenses 606.

Light received from the light source 608 by the collimation lens 602 is collimated and conveyed to the first array of micro-lenses 604. Each micro-lens in the first array of micro-lenses 604 then concentrates a portion of the collimated beam into respective strips having a width less than the portion of the collimated beam which is concentrated (i.e. a width at the respective micro-lens 604). Each strip of light is incident on a respective lens of the second array of micro-lenses 606. More specifically, each (first) lens of the first array of micro-lenses 604 directs and concentrates the portion of the collimated beam, i.e. a respective strip, onto the corresponding (second) respective lens of the second array of micro-lenses 606 with which the first lens forms a respective micro-lens pair of the set of respective micro-lens pairs 610.

Each lens of the second array of micro-lenses 606 collimates the concentrated strip received from the respective lens of the first array of micro-lenses 604, such that the second array of micro-lenses 606 directs a plurality of parallel beams 612 towards an LCOS or other display device (not shown in FIG. 6A).

Because the beam of a single light source 608 is used to produce, by the set of respective micro-lens pairs 610, a plurality of parallel beams 612, the illumination system 600 embodied in FIG. 6A may be considered an illumination system employing or having a single colour channel.

In this embodiment, the first array of micro-lenses 604 and the second array of micro-lenses are each cylindrical, striped or chequered. In some embodiments, the first and second arrays of micro-lenses 604, 606 are the same shape, and/or both of the arrays 604, 606 forms an array having a shape other than cylindrical, striped or chequered.

In some embodiments, the first and second arrays of micro-lenses 604, 606 are differently shaped, and/or one or both of the arrays 604, 606 forms an array having a shape other than cylindrical, striped or chequered.

FIG. 6B is a schematic illustration depicting, on the left, a striped arrangement 650 of micro-lenses in an array and, on the right, a chequered arrangement 652 of micro-lenses in an array. These arrangements 650, 652 represent different embodiments of the micro-lens arrays 604, 606 of the single colour channel illumination system 600.

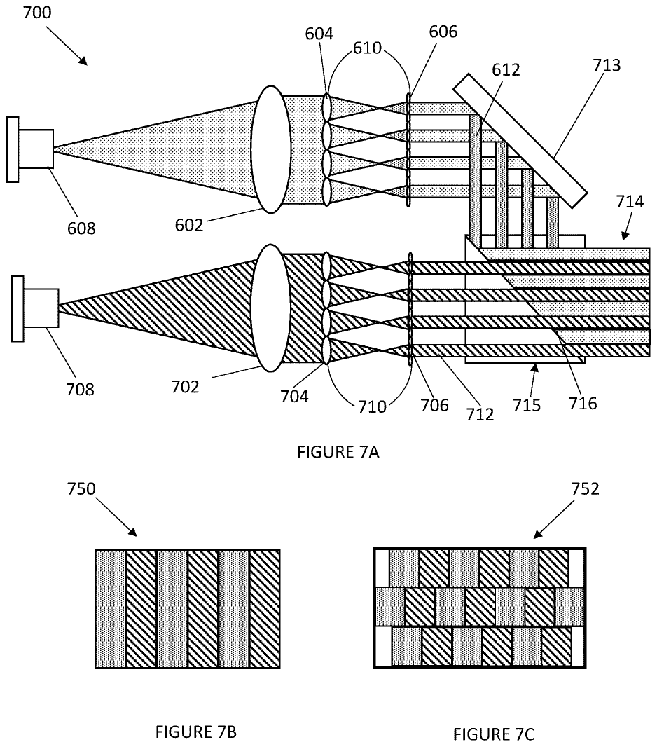

FIG. 7A is depicts a further illumination system 700 comprising the illumination system 600 of FIG. 6A, i.e. the collimation lens 602, the first array of micro-lenses 604, the second array of micro-lenses 606, and the light source 608.

The further illumination system 700 further comprises a further collimation lens 702, a further first array of micro-lenses 704, a further array of micro-lenses 706, and a further light source 708.

Together, the further first array of micro-lenses 704 and the further second array of micro-lenses 706 may be considered to form a further set of respective micro-lens pairs 710, in which further set of respective micro-lens pairs 710 each micro-lens pair comprises a micro-lens of the further first array of micro-lenses 704 and a micro-lens of the further second array of micro-lenses 706.

Light received from the light source 708 by the collimation lens 702 is collimated and conveyed to the first array of micro-lenses 704. Each micro-lens in the further first array of micro-lenses 704 then concentrates a portion of the (further) collimated beam into respective (further) strips having width less than the portion of the further collimated beam which is concentrated. Each further strip of light is incident on a respective lens of the further second array of micro-lenses 706. More specifically, each (further first) lens of the further first array of micro-lenses 704 directs and concentrates the portion of the further collimated beam, i.e. a respective further strip, onto the corresponding (further second) respective lens of the further second array of micro-lenses 706 with which the first lens forms a respective micro-lens pair of the further set of respective micro-lens pairs 710.

In this embodiment, each lens of the second array of micro-lenses 606 collimates the concentrated strip received from the respective lens of the first array of micro-lenses 604, such that the second array of micro-lenses 606 directs the plurality of parallel beams 612 onto a mirror 713. The mirror 713 re-directs (each of) the plurality of parallel beams 612 towards an optical device 715, e.g. a muxing optic such as a beam splitter. The optical device 715 comprises a partially reflective/partially transmissive surface 716. At least a portion of each of the parallel beams 612 is reflective by the surface 716 of the optical device 715. This is shown in FIG. 7A. A portion of the parallel beams 612 that is transmitted by the surface 716 is not shown in FIG. 7A.

In this embodiment, each lens of the further second array of micro-lenses 706 collimates the further concentrated strip received from the respective lens of the further first array of micro-lenses 704, such that the further second array of micro-lenses 706 directs the further plurality of parallel beams 712 to the optical device 715. At least a portion of each of the further parallel beams 712 is transmitted by the surface 716 of the optical device 715. This is shown in FIG. 7A. A portion of the further parallel beams 712 that is transmitted by the surface 716 is not shown in FIG. 7A. In this embodiment, the plurality of parallel beams 612 and the further plurality of parallel beams 712 are re-muxed in such a way that the beams spatially interlaced at the further optical device 715, thereby to produce a spatially interlaced light pattern 714 which may be considered formed of (or comprising) a first light pattern (i.e., the plurality of parallel beams 612) and a second light pattern (i.e., the further plurality of parallel beams 712).

The spatially interlaced light pattern 714 may subsequently be formed on, i.e. illuminate, an LCOS or other display device (not shown in FIG. 7A).

Because the beam of the light source 608 is used to produce, by the set of respective micro-lens pairs 610, the plurality of parallel beams 612, and the beam of the further light source 708 is used to produce, by the further set of respective micro-lens pairs 710, the further plurality of beams 712, the further illumination system 700 embodied in FIG. 6A may be considered an illumination system employing or having a multi-colour channel, and specifically—in this embodiment—a two-channel or two-colour channel arrangement. That is to say, the spatially interlaced light pattern 714 of this embodiment is formed of two light patterns, e.g. those formed by, respectively, the plurality of beams 612 originating from the light source 608 and the further plurality of beams 712 originating from the further light source 708.

However, in other embodiments, the further illumination system may be a multi-channel arrangement having, e.g., three channels, or four channels, or more channels. That is, some embodiments of the further illumination system produce spatially interlaced light patterns by spatially interlacing (by an optical device) three, or four, or more pluralities of beams originating from three, or four, or more light sources.

In embodiments, the spatially interlaced light pattern 714 is used to illuminate a display device such as a spatial light modulator (such as a liquid crystal on silicon spatial light modulator or LCOS SLM). The display device may be arranged to display a first hologram of a first picture and a second hologram of a second picture. The first and second holograms displayed on the display device may be spatially interlaced in a corresponding pattern to the spatially interlaced light pattern 714. In this way, light from the light source 608 (which has a first wavelength/first colour) illuminates the first hologram and light from the further light source 708 (which has a second wavelength/second colour) illuminates the second hologram. Examples of this are shown in FIGS. 7B and 7C.

FIG. 7B shows a striped illumination 750 of the LCOS or display device and FIG. 7C shows a chequered illumination 752 of the LCOS or display device. These illuminations 750, 752 each comprise different illumination “footprints”, each footprint being associated with different colour channels, i.e. different pluralities of beams 612, 712. Equivalently, each footprint is associated with a different hologram of the spatially interlaced light pattern 714. For example, in the two-colour channel embodiment of FIG. 7A, the spatially interlaced light pattern 714 which illuminates the LCOS or display device comprises a first hologram and a second hologram, which may spatially interlace to form, for example, the striped illumination 750 of FIG. 7B or the chequered illumination 752 of FIG. 7C, depending on the respective shapes of the arrays 604, 606, 704, 706. Regions which are part of different footprints, or holograms, are indicated in FIG. 7B by regions of different shading, and regions which form part of the same footprint, or hologram, are indicated in FIG. 7B by regions of same shading.

In the above embodiment, for each colour channel, a 3:1 (or similar) cylindrical micro lens array 4F system may be implemented for the first and/or second array of micro-lenses, and/or the further first and/or the further second array of micro-lenses. This tends to divide the full collimated beam into narrow, high intensity bands with gaps in between. This tends to advantageously maintain the overall intensity of the light beam but in the form of high intensity strips. In an exemplary embodiment in which three, e.g. RGB, striped colour channels are used, the RGB channels could then be muxed in such a way that the high intensity bands of the different colours are positioned adject to the other colours in the otherwise dark regions in the spatially interlaced light pattern 714 of FIG. 7A. This can be done by, e.g., de-centring the sources or optical devices.

In this manner, the full LCOS area may advantageously be illuminated but in red, green and blue bands.

It is envisaged that, in some embodiments, a simple stripped cylindrical micro-lens arrangement, or chequerboard staggered pattern, could be used for one or more of the arrays, depending on what is deemed by the user or designer more desirable from an LCOS illumination and/or image-quality perception point of view. To give stripped or chequered LCOS illumination

Advantageously, the spatially interlaced light pattern incident on the LCOS or display device tends to provide spatially separated LCOS illumination within the footprint/area of a single LCOS without a loss of illumination intensity.

Advantageously, the present invention tends to enable the use of a single LCOS device rather than three, without the associated time-sequential challenges.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. An illumination system for forming a light pattern, wherein the illumination system comprises:
a first telescope and a second telescope, each of the first telescope and the second telescope comprising:
a respective first array of micro-lenses arranged to receive light from a light source; and
a respective second array of micro-lenses, wherein each micro-lens of the respective first array is optically coupled to a respective micro-lens of the second array thereby to form an array of micro-lens pairs;
wherein each micro-lens pair of the array of micro-lens pairs is arranged to concentrate a portion of the received light into a local beam having a diameter less than those of the received light, such that each of the first telescope and the second telescope forms a respective light pattern comprising a respective array of discrete light regions; and
the illumination system further comprises an optical component arranged to spatially interlace the respective light patterns of the first telescope and the second telescope, thereby to produce a spatially interlaced light pattern.

2. The illumination system of claim 1, further comprising a display device for displaying holograms, wherein each of the first telescope and the second telescope is arranged to relay light to the display device such that the display device is illuminated by the spatially interlaced light pattern.

3. The illumination system of claim 2, further comprising a driver arranged to drive the display device to display thereon a first hologram of a first picture.

4. The illumination system of claim 3, wherein the driver is arranged to drive the display device to display the first hologram on a plurality of spatially separated first sub-areas of the display device.

5. The illumination system of claim 4, wherein the illumination system is arranged such that the light pattern of the first telescope illuminates each sub-area of the plurality of spatially separated first sub-areas of the display device.

6. The illumination system of claim wherein the driver is arranged to drive the display device to display thereon a second hologram of a second picture simultaneously to displaying the first hologram.

7. The illumination system of claim 6, wherein the driver is arranged to drive the display device to display the second hologram on a plurality of spatially separated second sub-areas of the display device, wherein the respective pluralities of spatially separated first and second sub-areas of the display device are spatially interlaced.

8. The illumination system of claim 7, wherein the illumination system is arranged such that the second light pattern of the second telescope illuminates each of the sub-area of the plurality of spatially separated second sub-areas of the display device.

9. The illumination system of claim 1, further comprising a light source arranged to emit light, wherein the first telescope is arranged to receive the light emitted from the first light source.

10. The illumination system of claim 9, further comprising a further light source arranged to emit light, wherein the second telescope is arranged to receive the light emitted from the second light source.

11. The illumination system of claim 1, wherein a dimension of one or more micro-lenses of the first array of micro-lenses is larger than a corresponding dimension of one or more micro-lenses of the second array of micro-lenses.

12. The illumination system of claim 11, wherein a dimension of each of the micro-lenses of the first array of micro-lenses is larger than a corresponding dimension of each of the micro-lenses of the second array of micro-lenses.

13. The illumination system of claim 1, wherein the respective light patterns of the first and second telescopes each comprise a respective array of spatially separated light regions.

14. A method for forming a light pattern by an illumination system, the method comprising:
receiving, by a first array of micro-lenses of a first telescope light, wherein each micro-lens of the first array of micro-lenses is optically coupled to a respective micro-lens of a second array of micro-lenses of the first telescope, thereby to form an array of micro-lens pairs;
receiving, by a further first array of micro-lenses of a second telescope light, wherein each micro-lens of the further first array of micro-lenses is optically coupled to a respective micro-lens of a further second array of micro-lenses of the second telescope, thereby to form a further array of micro-lens pairs;
concentrating, by each micro-lens pair of the array of micro-lens pairs and the further array of micro-lens pairs, a respective portion of the received light into a respective local beam having a reduced diameter relative to the respective portion of the received light, such that each of the first telescope and the second telescope forms a respective light pattern comprising a respective array of discrete light regions; and
spatially interlacing, by an optical component of the illumination system, the respective light patterns of the first telescope and the second telescope, thereby to produce a spatially interlaced light pattern.

15. The method of claim 14, further comprising relaying, by the first telescope and the second telescope, light to a display device such that the display device is illuminated by the spatially interlaced light pattern.

16. The method of claim 15, further comprising:
driving, by a driver, the display device to display on the display device a first hologram of a first picture.

17. The method of claim 16, further comprising driving, by the driver, the display device to display the first hologram on a plurality of spatially separated first sub-areas of the display device.

18. The method of claim 17, further comprising illuminating, by the light pattern of the first telescope, each sub-area of the plurality of spatially separated first sub-areas of the display device.

19. The method of claim 17, further comprising driving, by the driver, the display device to display on the display device a second hologram of a second picture simultaneously to displaying the first hologram of the first picture.

20. The method of claim 19, further comprising:
driving, by the driver, the display device to display the second hologram on a plurality of spatially separated second sub-areas of the display device, wherein the respective pluralities of spatially separated first and second sub-areas of the display device are spatially interlaced; and/or
illuminating, by the second light pattern of the second telescope, each of the subareas of the plurality of spatially separated second sub-areas of the display device such that light of the second light pattern is spatially modulated in accordance with the second hologram.
